(19) United States
(12) Patent Application Publication
(10) Pub. No.: US 2012/0037190 A1
(43) Pub. Date: Feb. 16, 2012

(54) METHOD AND DEVICE FOR INTERNALLY CLEANING CANS HAVING CORRESPONDING OPENINGS

(75) Inventors: Timo Jakob, Framersheim (DE); Steffen Kappel, Bad Kreuznach (DE); Thomas Stolte, Bad Kreuznach (DE)

(73) Assignee: KHS GmbH, Dortmund (DE)

(21) Appl. No.: 13/260,991

(22) PCT Filed: May 7, 2010
(86) PCT No.: PCT/EP2010/002804

§ 371 Date: Sep. 29, 2011

(30) Foreign Application Priority Data
May 12, 2009 (DE) 10 2009 020 957.3

(51) Int. Cl. B08B 9/20; B08B 9/093; B08B 9/44; B08B 9/30; B08B 9/34

(52) U.S. Cl. 134/22.18; 134/22.1; 134/24; 134/23; 134/44; 134/43

(57) ABSTRACT

The present invention relates to a method and a device for internally cleaning cans (1) having openings (2). According to the invention, an axially displaceable spray element (7) is provided for discharging a cleaning medium into the opening (2) in the course of (overhead) internally cleaning the can (1). To this end, said spray element (7) travels into the associated can (1) and back out again.

The invention relates to a method for the handling, in particular the internal cleaning, of cans with openings. —The opening is normally at the top of the can at the opposite end from a base of the can and is normally sealed by means of a lid after the can is filled with a fluid.

The internal cleaning of cans calls for a great deal of design-related and experimental expenditure, as exemplified by JP 2002096807 A. As is the case here, the internal cleaning process is performed by spraying-on a cleaning fluid within an aseptic atmosphere.

In addition DE 296 09 831 U1 is concerned with the insertion in portions of fluids into cans. The cans are moved in a circle using a rotor, whereby the cans stand upright on their base. How and whether the cans are subjected to prior internal cleaning remains unclear.

Furthermore the overhead handling of bottles is basically known about as is described in DE 42 29 580 A1. In this case, the bottles are rinsed, that is to say the inside of the bottles are washed out with a cleaning fluid. Special bottle grippers are used for this purpose and the mouth of the bottle is treated with a sterilization medium.

DE 10 2006 044 904 A1 operates in a similar manner whereby a spraying unit enters the inside of the bottle, preferably up as far as the base. Special devices are also required in this case to hold the bottle in the desired overhead position.

Such procedures do not have any application for the cleaning of the inside of cans with an opening. This is because, in particular, drink-cans are these days predominantly made from very thin steel plate in order to keep the costs and the use of materials down to the lowest possible level. As a consequence, the basic problem arises with mechanical manipulation of cans in that they will be in the worst case crushed, but are basically susceptible to their surface being damaged. Due to this, their subsequent sale becomes impossible.

For this reason, in normal practice, the process of cleaning the inside of cans with openings usually involves the use of so-called linear gravity rinsers. These kinds of devices generally have a spiral guide rail for the cans. The cans are then conveyed individually by the effects of gravity along the guide rail and are subjected to a 180° turn, so that at the end of the guide rail conveying process, they stand head downwards in the overhead position.

The cans in the overhead position are then treated with a cleaning medium. The cleaning medium is dispensed basically via a so-called fixed nozzle assembly onto the cans or into their interior. The cans are treated from the bottom upwards using this nozzle assembly, which has nozzles set at intervals extending lengthways from the respective opening.

As a result of the spacing of the nozzles from the opening, the jet of the cleaning medium is constantly interrupted and is, for example, reflected on the walls of the cans. Due to this, a relatively large amount of cleaning medium is needed and finally does not achieve any targeted internal cleaning. This results in increased costs that have to be taken into account. In summary, this invention is intended to provide a remedy for this.

The invention is based upon the technical problem of further developing a process for the inner cleaning of cans with openings in such a way that the cleaning effect will be enhanced and at the same time the amount of the requisite cleaning medium will be reduced.

As per the invention, a process is proposed for resolving this technical problem, characterized in that the can is basically held in place by means of adhesion: for example by a vacuum and/or by means of a preferably flexible clamping gripper that grips onto the can body or onto the can walls.

It is thereby ensured that the can is subjected to a gentle process of being held in place during the whole of its conveying process and in particular, whilst being cleaned inside. That can occur on the one hand due to the vacuum or negative pressure that is created or generally due to adhesion and/or on the other hand due to the fact that one or several clamping grippers engage with the can on its body or on its walls and hold the can in place. In the first of the aforementioned cases, the generation of the negative pressure or vacuum is seen as being basically a suction holder or generally an adhesive holder, which holds the can in place around its circumference or the can body by means of a vacuum. In this way it is ensured that the can is subjected to virtually no mechanical pressurization and as a result, is not damaged.

A comparable damage-free fixing of the can is achieved for the case mentioned above in such a way that as per the invention it is operated using one or several flexible clamping grippers. This clamping gripper is as a rule adapted to the peripheral contour of the can or the can body. Generally the clamping gripper is curve-shaped. Usually the radius for the curve or curve-shaped clamping gripper and that of the can body are basically matched to each other. In order to achieve the adhesion of the can to the (preferably flexible) clamping gripper, the clamping gripper can be made from a material that has higher adhesive properties than for example metal, i.e. from an elasticised plastic.

Obviously it is conceivable at this point to install an additional means of increasing the adhesion between the clamping gripper and the can. In this way, the clamping gripper in question can, for example, be equipped with a film of liquid that is, for example, water and/or oil based, on its inner side that faces towards the can. A liquid feed line to the respective clamping gripper might provide an appropriate way of feeding the liquid. In addition, the clamping gripper is equipped in this case with one or several internal openings towards the can body, through which the aforementioned liquid in question is discharged. In this case, the can is fixed by means of adhesion, whilst at the same time being held in place by the clamping gripper.

Alternatively, or at the same time, the clamping gripper can also function in the form of the suction holder that has already been described and then provides the negative pressure or vacuum that is used to ensure that the can is securely held in place during the described process. This applies at least provided that no stabilizing liquid is inserted into the can that stabilizes its walls or the can body.

This process that has not so far been considered to be possible in the art because the wall of the can or the can body in its empty and unfilled condition is exceptionally fragile and susceptible to damage, which may preclude its subsequent filling and sale. In any case, as per the invention, the can is exposed to virtually no mechanical pressurization on its sides and will not be damaged. This applies at least for the cleaning process or the internal cleaning process that is described, but can also apply during the turning process and/or at the final filling process. That means that the can undergoes an exceptionally gentle handling process.

The cans are cleaned as per the type of design of this invention by a spraying unit that is fixed in terms of its height, but which is not axially manoeuvrable, for discharging the cleaning medium into the cans opening.

However, as per the previously mentioned type of design, an axially manoeuvred or manoeuvrable spraying unit for the discharging of the cleaning medium into the opening for the (overhead) internal cleaning travels in and out of the can. The cans are generally treated with the cleaning medium along a conveyor, and in particular a circular conveyor, in the described overhead position. It has in addition proved to be advantageous if the can is guided into the aforesaid overhead position prior to its being cleaned or internally cleaned.

After its internal cleaning, the respective can is able to be further conveyed in the overhead position in question. But by way of an alternative, or in addition, it is also conceivable that the can after its internal cleaning is turned from the overhead position by approx.180° into its filling position, because for the most part the filling of the cans is performed in conjunction with the described internal cleaning process and the opening is then sealed. In the course of this the lid is applied to the opening and joined to the can walls. That is to say, the can in question is usually designed in a hollow cylindrical shape and has a circular opening, which is closed-up after the cleaning or after being filled with the desired liquid using a lid.

In terms of the can, it is in general a matter of having a rotationally symmetric and essentially cylindrical drinks-can, although in the context of the invention other cans can naturally also be handled as described. For the most part however, the process is used for drinks-cans, which have exceptionally low wall thickness and are as a result particularly fragile and liable to be damaged when being mechanically handled.

In addition, this has turned out to be the case if the can in question is subjected to a counterforce to counter the flushing force during the cleaning process. In this case, the invention starts from the knowledge that the axially-moving spraying device, which travels in and out of the opening for the (overhead) internal cleaning of the can in question, applies the described flushing force to the base of the can. The danger then arises in connection with the suction holder or generally adhesive holder, which usually holds the can around its outer circumference, that the can may be released from the suction holder as a result of this built-up flushing force. The counterforce, which in the main is provided by a bottom stop that acts as the overlapping supporting arm for the respective can, operates to counteract this.

This bottom stop or the supporting arm that is formed in this way ensures that the can base is subjected to an offsetting counterforce in relation to the flushing force and as a result the danger of the can being, for example, released by the suction holder does not arise.

Generally, with regard to the cleaning medium, this involves a cleaning fluid and/or a cleaning gas. In this case, the operation is for the most part performed both with a cleaning fluid and a cleaning gas. The can is then flushed out from the inside outwards with the respective cleaning fluid. The axially-moving spraying unit then travels preferably, but not essentially, into the respective can. This type of axial movement of the spraying unit relates in this respect to the rotationally symmetrical axis of the can or of its longitudinal axis. After the flushing process with the cleaning fluid, the axially moved spraying unit travels outwards once again from the can.

As a result of the overhead position that has been assumed during the cleaning of the can, any cleaning fluid can drop out of the opening assisted by gravity. As further support for this process, it has been proven to be worthwhile if, after flushing with the cleaning fluid, the inside of the cans are flushed-out with a gaseous cleaning medium and, in particular, a pressurized sterilizing medium. In this way any left-over cleaning fluid in the interior is expelled from the can.

Compared to the current state of the art, a clearly improved cleaning result has been observed in the way that the axially and preferably intermittently moved spraying unit travels in and out of the opening for the (overhead) internal cleaning of the can. This is because, with the use of the spraying unit or by means of the nozzle that is fitted at the head, the cleaning medium or cleaning fluid that is applied is aimed directly towards the base of the can. The cleaning fluid or the cleaning medium flows from there in a radial direction up to the walls of the can and then aided by gravity along the walls of the can to the opening of the can. In this it should be understood that the respective spraying unit usually travels centrally in and out of the can, in order to enable a uniform internal cleaning operation to be performed.

It can thus be ensured that the (overhead) internal cleaning along the circular conveyor is performed and that in each case, a separate and axially-moving spraying unit is inserted for every can that is to be cleaned. That means that during the (overhead) internal cleaning, the can and the spraying unit move synchronously with each other along the circular track provided by the circular conveyor. In the course of this joint circular rotation, it is only the distance between the spraying unit or its nozzle on the top and the can or its opening that alters in relation to the base of the can.

It should be thereby understood that the extent of the insertion of the spraying unit into the can, as well as the duration that it remains inside the can, is able also to be varied by a corresponding control of the curved movement of the spraying unit. That is to say, the spraying unit can fully perform an overall fully-controlled movement with respect to the corresponding fixed can and also during the joint circular rotation along the circular conveyor. Obviously moving the can and the respectively related spraying unit along a linear conveyor is also basically conceivable and is within the scope of the invention. But in both cases, it has to be arranged that the can that is to be cleaned and the spraying unit move along synchronously in the course of the cleaning process. A change of the axial distance of the spraying unit in relation to the can takes place, whilst the spraying unit actually travels in and out of the can or of its opening and does so in an axial direction.

Various procedures are conceivable in order to bring the can into the requisite overhead position for internal cleaning from the filling position that has been assumed with the opening upwards during the carrying-out of the internal cleaning or after the production process. In this way the cans are turned from the filling position into the overhead position during the cleaning process or at the inlet side of a device for the internal cleaning. But it is also possible to introduce the cans into the desired overhead position prior to reaching the relevant device for the (overhead) internal cleaning.

It is conceivable here to operate with for example an in-feed star or in general with an in-feed conveyor, which automatically turns the cans from the filing position into the overhead position. The same thing may take place from the inlet side. That is to say, the cans are able to be turned after the described inner filling process from the overhead position that has been in so doing adopted into the filling position on the exit side of the device for the (overhead) internal cleaning that is installed at this point. But it is also possible to have a special and separate turning device after passing the device for the (overhead) internal cleaning at the exit or in the exit of the cans. Obviously installing such a separate turning device in the or at the entry to the relative device for the (overhead) internal; cleaning is also within the scope of the invention.

Any conceivable cleaning fluid can be used as the cleaning medium. But it is also possible to flush the cans with ionized air or another gaseous cleaning medium. Thus any conceivable rinsing processes with water and/or disinfectant and/or air as the cleaning medium are encompassed by the invention. The invention crucially exploits the fact that the cans that are to be cleaned are regularly held in place by a vacuum or in general by means of adhesion, as a result of which there is no risk of damage, not even with the respective lower strength of the walls of the cans. This is clearly different from the (overhead) internal cleaning of bottles. As is described for example in DE 10 2006 044 904 A1. Because in that case mechanical grippers are used that—even with thin PET bottles—can grasp the so-called neck ring without causing damage. But such procedures cannot be switched over to cans.

Thanks to the vacuum holding system the cans are fixed in an entirely damage-free and problem-free manner and are able in their overhead position to be subjected to the described (overhead) inner cleaning without any problems. This is particularly effective because provision has been made for an axially moved or movable spraying unit with the nozzle located on its top side, so as to be able dispense the desired cleaning medium. A particularly effective internal cleaning is provided because the spraying unit with its head-side located nozzle travels in and out of the opening of the can. Any items left over from the production process are in this way removed from the inside of the cans. These procedures can obviously also be used in principle for cleaning the outside of the respective cans. All of this is achieved whilst having regard to a clearly reduced equipment-related expenditure and with, as a consequence, reduced costs compared with the state of the art as per for example JP 2002096807 A.

The invention is explained in more detail here-below using drawings that show an example of a design; the following are illustrated:

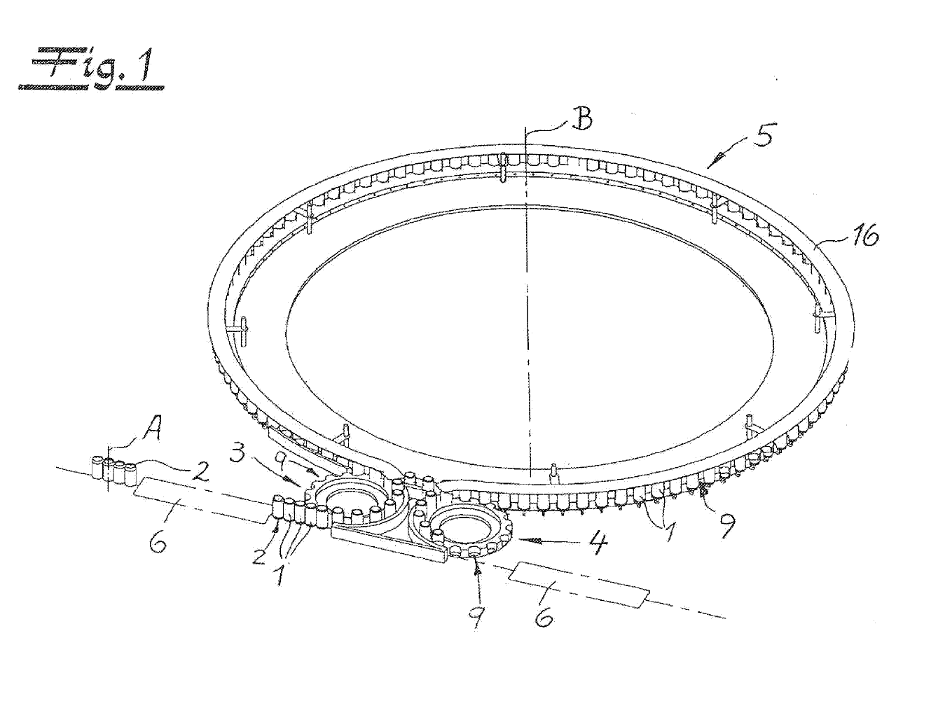

FIG. 1 a device as per the invention for the (overhead) internal cleaning of cans in an overhead view,

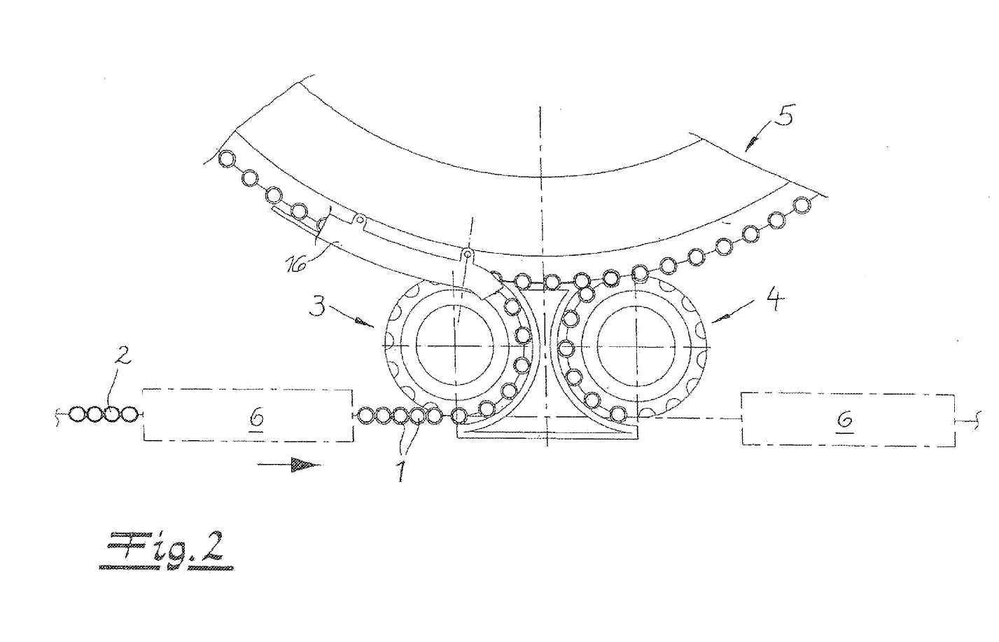

FIG. 2 the object as per FIG. 1 in a detailed cross-section drawing,

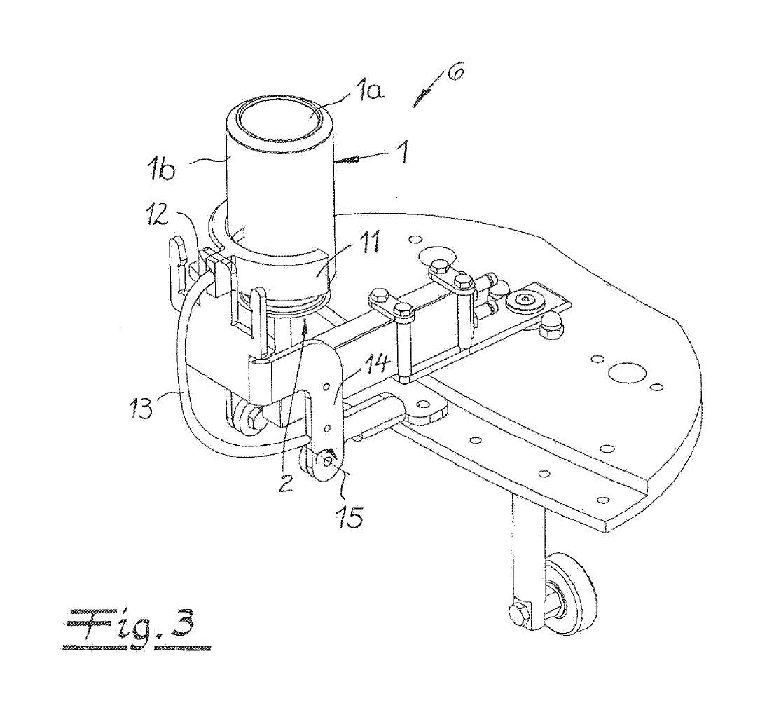

FIG. 3 a suction holder, as is used in the device that is described and

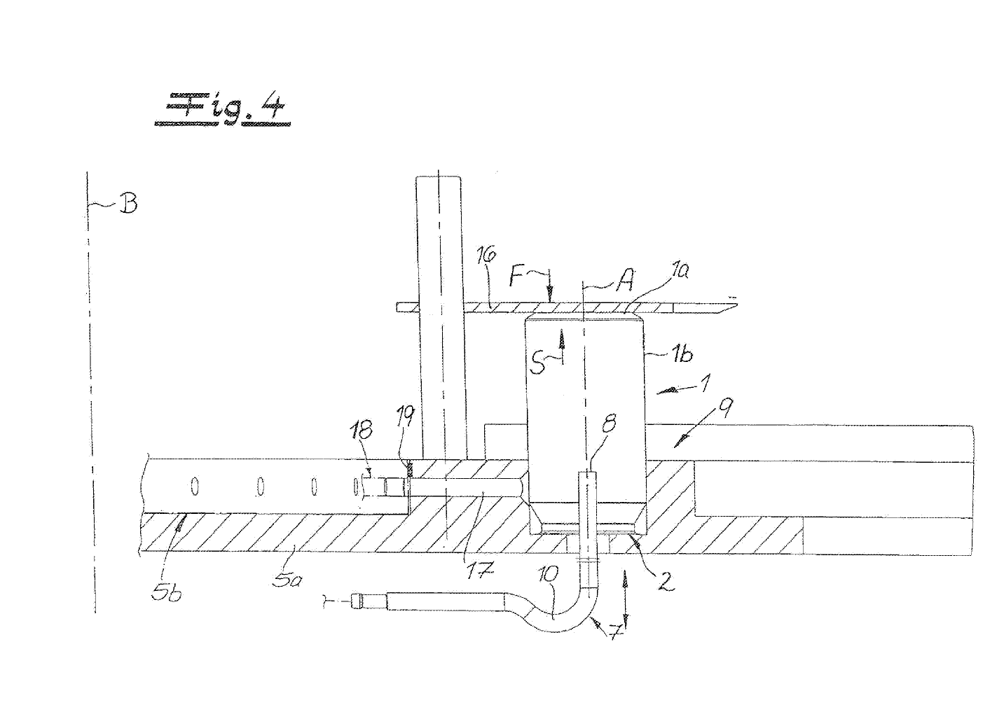

FIG. 4 the object as per FIG. 3 in a detailed cross-section drawing,

A device for the handling and preferable for the cleaning of cans 1 with openings 2 is shown in the drawings. Reference is made here primarily to the internal cleaning of the cans 1, although an outside cleaning is also possible with the device and the processes that are still to be described. In terms of the cans 1, these relate in the example of the design and not restrictively to drinks-cans normally made from sheet steel with a minimal wall thickness (<0.1 mm). The cans 1 are rotationally symmetrically shaped in relation to an axis A, so that the opening 2 is in the form of a circular disc. That is obviously not essential, because basically also, for example, octagonal or hexagonal cans with a correspondingly shaped opening can be processed.

The device that is illustrated for the (overhead) internal cleaning or (overhead) internal cleaning of the cans 1 has, as part of its basic structure, an in-feed conveyor 3 and an exit conveyor 4. The cans 1 are transferred by means of the in-feed conveyor 3 onto a circular conveyor or a concentric conveyor 5 or what is in fact called a carousel. A can-turning device 6 is inserted upstream of the in-feed conveyor 3 or an in-feed star installed at this point. A further can-turning device 6 is located downstream from the exit conveyor 4. The cans 1 that have been conveyed into this position in a filling position with upwards-pointing opening 2 are transposed into a subsequently assumed overhead position, in which the cans 1 reach the in-feed conveyor 3 by the use of the can-turning device 6 in front of the in-feed conveyor 3.

The cans 1 in the overhead position are then transferred from the in-feed conveyor 3 onto the curved conveyor or circular conveyor 5. The cans 1 at the exit from the circular conveyor 5 are channelled onto the exit conveyor 4 and from there into a further can-turning device 6. By means of this further can-turning device 6, the cans 1 are then transposed from the earlier assumed overhead position once again into the filling position and are then ready for being filled with, for example, a CO₂-containing drink and then the final applying of a lid for sealing the opening 2. A linear conveyor instead of a circular conveyor assisted by the in-feed conveyor 3, the exit conveyor 4 and the circular conveyor 5 is obviously also possible and is included.

Both the in-feed conveyor 3 and the exit conveyor 4 and then the circular conveyor 5 have receptacles 9 on the circumference, in which the individual cans 1 are held and transported singly along the circular routings that can be seen. That is obviously not essential as, in terms of the invention, at this point a linear conveyor could be used instead of the circular conveyor 5. The in-feed conveyor 3 and the exit conveyor 4 can be also linear-driven as described.

The relevant spraying units 7, which can be seen in particular in FIG. 4, are of importance for the invention. Each spraying unit 7 is fitted on the top side with a nozzle or rather a corresponding outlet 8 for a cleaning medium that is dispensed from the nozzle or the outlet 8. By this means each individual can 1 or each receptacle 9 of the circular conveyor 5 is allocated one individual spraying unit 7. The spraying unit 7 that is part of this travels along a circular track together with the receptacle 9 or the can 1 that is placed into this receptacle 9, because the circular conveyor 5 revolves around an axis B. This axis B represents the axis/axle of the machine.

The circular conveyor 5 or a corresponding rotor 5a, which moves with respect to a fixed section 5b or stator of the circular conveyor 5 in the circular around the axis B, can be seen in particular in FIG. 4. As part of this process, the spraying unit 7 and jointly with the spraying unit 7 its outlet 8 or a nozzle 8 that is installed at this point, moves in and out axially in relation to the axis A of the respective can 1. That is indicated by a double-ended arrow in FIG. 4. For this purpose, every spraying unit 7 has its own drive or is moved along a prescribed mechanical curve.

In this way, the axially moving spraying units 7 can be inserted through the opening 2 into the can 1 for dispensing the cleaning medium. As in this process the outlet opening or nozzle 8 of the spray medium 7 is positioned centrally with regard to the can 1, that is to say, it moves axially on the axis A, it is thereby ensured that the cleaning fluid that is dispensed, by way of this example, from the outlet opening of the nozzle 8, impacts centrally on the base of the can 1a. Commencing from this base of the can 1a or starting from its centre, the cleaning fluid spreads, in the example of the model given, along the hollow cylindrical walls 1b and eventually leaves through the opening 2 assisted by gravity.

It can be seen that the individual cans 1 in the receptacle 9 of the circular conveyor or rotating conveyor 5 are held in place and in fact by means of negative pressure or through a vacuum that is created in the receptacles 9 or generally by means of adhesion. Thus, the already-mentioned spraying unit 7 with the relative outlet of the nozzle 8 is allocated to each receptacle 9. It is additionally clear from FIG. 4 that each spraying units 7 has a siphon 10 in its feed-line in order to prevent the ingress of contamination.

The structure of the can-turning device 6 is clarified by FIG. 3. It can be seen that the individual can 1 is gripped and held in place by an adhesive holder 11 or a suction holder 11 in the can-turning device 6. This suction holder 11 encloses—at least partially—the hollow cylindrical walls of the can 1b of the can 1. For this purpose, the suction holder 11 is illustrated in the shape of an arc of a circle within the context of the example and has a suction connection 12 connected to the suction line 13 for the supply of negative pressure

In each case, the suction openings that are provided inside the suction holder 11 ensure that the can 1 with its walls 1b is fixed within or onto the suction holder 11. Instead of applying negative pressure or a vacuum to the suction openings, an adhesive means such as, for example, water can be exuded and fix the can 1. In order to now turn the can 1, the suction holder 11 is connected to a pivoting arm 14, which enables the suction holder 11 to be pivoted around a horizontal axis 15 as shown in the example of the design. This is indicated by an arrow in FIG. 3. As a result of this, the can 1 is guided from out of its filling position before the passing of the can-turning device 6 as per FIG. 1 into the overhead position that is illustrated in FIG. 3, in which the can 1 is gripped on its can walls 1b by means of the suction holder 11 and then the pivoting arm 14 is swivelled around its axis 15 in the clockwise direction as is shown in FIG. 3.

An alternative form of the design of the can-turning device 6 operates in a comparable way, in which there is no suction holder 11 installed, but in place of this, an arch-shaped clamping gripper that is of a more or less similar design engages onto the walls 1b of the can 1. In this case, the aforesaid clamping gripper is designed like the suction holder 11 and is also arch-shaped and which has a radius, which corresponds essentially to that of the hollow cylindrical can 1. The requisite adhesion between the can 1 and the clamping gripper is either provided by the aforesaid clamping gripper being made from a flexible (plastics) material that has the necessary adhesion with regard to the metal can 1 or by an adhesive means/substance—for example a fluid such as water or oil—being dispensed via openings that are present in each case in the inner sides of the clamping gripper.

This adhesive means/substance provides the necessary adhesion of the can 1 to the clamping gripper, which in contrast to the suction holder 11, in general foregoes the need for an additional intervention with a vacuum or negative pressure. In this vacuum or negative pressure means in the context of the invention, a pressure that is less than the atmospheric pressure, is sufficient and suitable to be able to hold the can 1 in question in place. Alternatively in this respect—as is described—the operation can be performed with the flexible clamping gripper and/or by resorting to an additional adhesion means/substance (water or oil). Obviously these measures can also be combined.

As a result of this, the can 1 is positioned on the exit side of the can-turning device 6 in the overhead position illustrated in FIG. 3 such that it can then be transferred onto the in-feed conveyor 3 and from there to the circular conveyor 5. The cleaning process described with reference to FIG. 4 is then carried out in this overhead position as per FIG. 3. During the cleaning process the respective can 1 in its overhead position is subjected to a counterforce F, which is directed inversely against a flushing force S. This is illustrated in FIG. 4.

In fact, the cleaning fluid that leaves the outlet opening or the nozzle 8 or the corresponding cleaning fluid impacts on the bases of the cans 1a with the flushing force S. The device has a bottom stop or a supporting arm 16 so that the can 1 is not pressed out of its receptacle 9 during this process. As a rule, each receptacle 9 is thus allocated a bottom stop or supporting arm 16. It can be seen from FIG. 1, that the example of the design has at this point a bottom stop or supporting arm 16 that extends over virtually the whole circumference of the circular conveyor 5. This bottom stop or supporting arm 16 ends in each case in the area, in which the cans 1 are transferred in their overhead position from the in-feed conveyor 3 to the circular conveyor 5 or in the area, in which the cans 1 are further transported after their cleaning from the circular conveyor 5 into the exit conveyor 4.

In conclusion, FIG. 4 again makes it clear that each receptacle 9 of the circular conveyor 5 is equipped with a suction connection or vacuum channel 17. The suction connection or vacuum channel 17 connects for its part with vacuum lines 18 that are located in the fixed section 5b or the stator 5b of the circular conveyor 5. When the rotor 5a is turning around the stator 5b, the respective vacuum line 18 is connected in pre-determined angles of arc intervals to the suction connection or to the associated vacuum channel 17 so that the can 1 is held without any problems and by suction power in the associated receptacle 9 in its overhead position. An additional seal 19 ensures that the stator 5b is sealed against the rotor 5a and the vacuum lead 18 can have a precisely targeted impact on the suction connection 17 or rather the vacuum channel 17 that is connected to it.

Instead of the suction connection 17 or the vacuum channel 17 that is connected to it, the receptacle 9 may also as an alternative be equipped with a suction holder 11 like the can-turning device 6 and vice versa. That is to say, the cans 1 are held in place in the respective receptacles 9 within the device that is illustrated by means of a vacuum that is generated or generally by adhesion. Alternatively, or in addition, the cans 1 can also be fixed in the receptacle 9 by means of comparable single or several clamping grippers, in the same way as has been described with reference to the can-turning device 6. In this case, an adhesive means/substance may then be fed for example via the vacuum channel 17 and in fact instead of the described alternative, in accordance with which the vacuum channel 17 is subjected to negative pressure. The recourse to just one or several flexible clamping grippers for the adhesive and damage-free fixing of the can 1 is possible also within the context of the receptacle 9.

All of these methods that have been described for holding the can 1 in place without damaging it can therefore be utilized for the respective can-turning devices 6, the in-feed conveyor 3, the exit conveyor 4 and the conveyor or circular conveyor 5 and indeed in summary both singly and cumulatively.

1-14. (canceled)

15. A process for internal cleaning of cans, each of said cans having a respective opening, said process comprising holding a can using a clamping gripper on walls of said can.

16. The process of claim 15, further comprising causing an axially moving spraying unit for the emission of a cleaning medium to travel in and out of the opening for overhead internal cleaning of said can.

17. The process of claim 16, further comprising treating said can with said cleaning medium in the overhead condition along a conveyor.

18. The process of claim 16, further comprising treating said can with said cleaning medium in the overhead condition along a circular conveyor.

19. The process of claim 15, further comprising guiding said can into an overhead position prior to internally cleaning said can.

20. The process of claim 4, further comprising conveying said can in the overhead position after internally cleaning said can.

21. The process of claim 19, further comprising turning said can in the overhead position into a filling position after internally cleaning said can.

22. The process of claim 15, further comprising, during a cleaning process, subjecting said can to a counterforce against a flushing force.

23. The process of claim 16, further comprising, after internally cleaning said can, flushing said can with a gaseous pressurized sterilizing medium.

24. An apparatus for cleaning cans, each of said can having an opening, said apparatus comprising: a conveyor; and a can-turning device associated with said conveyor, said can-turning device being equipped with at least one of an adhesive holder and a clamping gripper for fixing a can.

25. The apparatus of claim 24, further comprising an axially movable spraying unit for emitting a cleaning medium, said spraying unit being configured to travel in and out of an opening of a can for overhead internal cleaning of said can.

26. The apparatus of claim 24, wherein said conveyor comprises: several receptacles for said cans, and corresponding spraying units for each of said receptacles.

27. The apparatus of claim 24, further comprising an in-feed conveyor for transferring cans to be cleaned onto said conveyor.

28. The apparatus of claim 24, further comprising an exit conveyor for removing cleaned cans from said conveyor.

29. The apparatus of claim 25, wherein said cleaning medium comprises a cleaning fluid.

30. The apparatus of claim 29, wherein said cleaning fluid comprises a cleaning gas.

31. The apparatus of claim 24, further comprising a plurality of can-turning devices, each can-turning device being equipped with at least one of an adhesive holder and a clamping gripper for fixing a can.
